(19) United States
(12) Patent Application Publication
(10) Pub. No.: US 2016/0125524 A1
(43) Pub. Date: May 5, 2016

(54) SYSTEMS AND METHODS FOR PERSONAL FINANCE MANAGEMENT

(71) Applicant: Powell Loskamp, Los Gatos, CA (US)

(72) Inventor: Powell Loskamp, Los Gatos, CA (US)

(21) Appl. No.: 14/533,081

(22) Filed: Nov. 4, 2014

(51) Int. Cl. G06Q 40/00

(52) U.S. Cl. CPC G06Q 40/00

(57) ABSTRACT

Embodiments of the invention disclosure provide methods and systems facilitating users personal finance management. According to an embodiment, a method for managing finances of a user, includes: providing a GUI including finance management option(s) at a computing device of the user; receiving a selection of at least one of the finance management options from the user; requesting money flow input(s) from the user based on the selection of the finance management option; generating a pictorial representation comprising at least one node and one or more sub nodes attached to the node via connector(s); displaying the pictorial representation at the computing device using one or more colors and financial indicator(s); and allowing the user to manipulate the at least one of the node and the sub nodes, the user may manipulate by selecting and dragging the at least one of the node and the sub nodes.

### CROSS-REFERENCE TO RELATED APPLICATIONS

This present disclosure claims the benefit of U.S. Provisional Application Ser. No. 61/899,506, filed on Nov. 4, 2013.

### TECHNICAL FIELD

The presently disclosed embodiments relate to personal finance management systems, and more particularly to methods and systems facilitating a user to manage his/her money flow, budget, business, project, and so forth.

### BACKGROUND

There is financial literacy crisis in many countries today. According to US Department of Treasury, about 49% of Americans have trouble in managing their “day-to-day” finances. Further, according to the “2010 Consumer Financial Literacy Survey Report” conducted by Harris International states that: (i) 50% of Americans have less than one-month's income in savings; (ii) 65% of Americans have not looked at their credit score in the past 12 months; (iii) 57% of American households do not have a budget. The same report indicates that more than half of all of adults in the US are living hand to mouth or less than one month of income in saving. Financial awareness for the people is also important so that the people can manage their finances in a better manner.

The current solutions available in the Personal Financial Management application market are bookended by two competing models, the traditional “high user engagement” or the new “easy to use”.

An existing solution called “Quicken” is a traditional, high user engagement model that uses spreadsheets, charts, and graphs. The “Quicken” requires high level of financial sophistication to operate. Though laborious, “Quicken” contributes to greater understanding and control as a user interacts with their personal finances.

Another existing web-based solution called “Mint.com” leads the way as an easy to use, attractive, low touch, read-only application. After aggregating the user's financial data, the “Mint.com” presents data in an attractive bank statement form with personalized info-graphics. Little to no engagement is required or request of the Mint user, but “Mint.com” provides little to no financial education to its user(s).

There exists another software solution called “You Need A Budget” (YNAB) software application. The YNAB helps the user to manage their finances, but it suffers from following limitations. The user is charged with some fixed cost after free-trial period of 7 days. Further, the information is presented to user in form of a user interface that looks like a bank statement; the user might not be very comfortable in understanding the bank statement. In addition, the YNAB does not utilize the power of Internet, i.e. it is not accessible through Internet website and real time management of finances may not be possible. Further, the user is required to enter all his/her finance related data entries manually; this may consume lot of time. Further, the YNAB suggests that the user is required to spend 10 minutes twice a week to enter and categorize all income and purchases to keep their balance up to date. The manual entering of each expense can be a tedious process for the user.

These solutions provide no basic financial literacy to the users. Moreover, these solutions present information as a bunch of numbers, charts, and graphs to the user, which may not be easy to understand for the users. In light of above discussion, technical solutions are desired that may facilitate users to manage their personal finances and budget with ease and convenience. Further, solutions are desired that may provide financial literacy to the users.

### SUMMARY

An embodiment of the present disclosure provides a method for managing finances of a user. The method includes providing, by a display manager, a graphical user interface (GUI) including a plurality of finance management options to the user. The GUI is displayed at a computing device of the user. The method also includes receiving, by an input/output (IO) module, a selection of at least one of the finance management options from the user. The method further includes requesting, by the IO module, one or more money flow inputs from the user based on the selection of the at least one of the finance management options. The method furthermore includes generating, by a budget tracking module of a finance management system, a pictorial representation based on at least one of the selection of the at least one of the finance management options and received one or more money flow inputs. The pictorial representation includes at least one node and one or more sub nodes attached to the at least one node via one or more connectors. The method also includes displaying, by the display manager, the pictorial representation at the computing device using one or more colors and at least one financial indicator. The method further includes allowing the user to manipulate the at least one of the node and the sub nodes. The user manipulates the node or/and the sub nodes by selecting and dragging the at least one of the node and the sub nodes.

Another embodiment of the present disclosure provides a system for managing finances of a user. The system includes a graphical user interface (GUI) including a number of finance management options to the user. The GUI is displayed at a computing device of the user. The system also includes an input/output (IO) interface configured to: receive a selection of at least one of the finance management options from the user; and receive one or more money flow inputs based on the selection of the at least one of the finance management options from the user. The system also includes a finance management system including a budget tracker configured to generate a pictorial representation based on at least one of the selection of the at least one of the finance management options and received one or more money flow inputs. The pictorial representation comprises at least one node and one or more sub nodes attached to the at least one node via one or more connectors. The budget tracking module also allows the user to track the financial transactions associated with the user. The system further includes a display manager configured to display the pictorial representation and the GUI at the computing device using one or more colors and at least one financial indicator. The system also includes a database configured to store the one or more flow inputs and the pictorial representation. Further, the user manipulates the at least one of the node and the one or more sub nodes by selecting and dragging the at least one of the node and the one or more sub nodes.

### BRIEF DESCRIPTION OF THE DRAWINGS

The illustrated embodiments of the disclosed subject matter will be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1A is a schematic illustrating an exemplary system including a computing device, in accordance with an embodiment of the present disclosure.

FIG. 1B is a schematic illustrating another exemplary system including a mobile phone, in accordance with another embodiment of the present disclosure.

FIG. 1C is a schematic illustrating an exemplary system including a computer, in accordance with an embodiment of the present disclosure.

FIG. 1D is a schematic illustrating an exemplary system including a laptop computer, in accordance with an embodiment of the present disclosure.

FIG. 1E is a schematic illustrating an exemplary system including a tablet computer, in accordance with an embodiment of the present disclosure.

FIG. 2 is a schematic illustrating structural components of an exemplary computing device for facilitating a user to manage his/her personal finances, budgets, projects, and so forth, in accordance with an embodiment of the present disclosure.

FIG. 3 is a schematic illustrating structural components of a finance management system, in accordance with another embodiment of the present disclosure.

FIG. 4 is a schematic illustrating an exemplary process of updating expenses and purchases into one or more categories, in accordance with an embodiment of the present disclosure.

FIG. 5 is a schematic illustrating an exemplary pictorial representation including one node, in accordance with an embodiment of the present disclosure.

FIG. 6 is a schematic illustrating another exemplary pictorial representation including two nodes, in accordance with another embodiment of the present disclosure.

FIG. 7 is a flowchart illustrating a method for facilitating a user to manage his/her personal budget, in accordance with an embodiment of the present disclosure.

FIGS. 8A-8B depicts a snapshot of a GUI of a finance management system running on a mobile phone, in accordance with an embodiment of the present disclosure.

FIGS. 9A-9B illustrates a snap shot of a Net Worth Interface on a mobile phone, in accordance with an embodiment of the present disclosure.

FIG. 10 illustrates a snap shot of a web based GUI of a finance management system, in accordance with an embodiment of the present disclosure.

FIG. 11 is a schematic illustrating a functional block diagram of a computing device and system on a network in which the present disclosure can find application.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

It will be readily understood that the components of the disclosed embodiments, as generally described and illustrated in the Figures herein, may be arranged and designed in a wide variety of different configurations. Thus, the following detailed description of the embodiments of the apparatus, system, and method of the disclosed subject matter, as presented in the Figures, is not intended to limit the scope of the disclosed subject matter, as claimed, but is merely representative of selected embodiments of the disclosed subject matter.

The functional units described in this specification have been labeled as managers, managing modules, and directors. A manager, a managing module, and/or director may be implemented in programmable hardware devices such as processors, digital signal processors, central processing units, field programmable gate arrays, programmable array logic, programmable logic devices, cloud processing systems, or the like. The manager, managing module, and/or director may also be implemented in software for execution by various types of processors. An identified manager and/or director of executable code may, for instance comprise one or more physical or logical blocks of computer instructions, which may, for instance, be organized as an object, procedure, function, or other construct. Nevertheless, the executables of an identified manager and/or director need not be physically located together, but may comprise disparate instructions stored in different locations which, when joined logically together, comprise the manager and/or director and achieve the stated purpose of the manager and/or director.

Indeed, a manager and/or director of executable code could be a single instruction, or many instructions, and may even be distributed over several different code segments, among different applications, and across several memory devices. Similarly, operational data may be identified and illustrated herein within the manager and/or director, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the disclosed subject matter. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

### DEFINITIONS

In this disclosure, the term “computing device” can include a digital electronic device having a display unit for displaying at least one graphical user interface to a user. The computing device can include, but is not limited to, a mobile phone, a computer, a tablet computer, a laptop computer, a personal digital assistant (PDA), a fax machine, or any appropriate device, device driver, client device, or system for a graphical user interface for an electronic device.

As used herein, a “graphical user interface” (GUI) can include an interface on the computing device enabling a user to interact with the computing device. The GUI may include one or more finance management options. The term “finance management options” can refer to icons or images or text corresponding to at least one functionality provided by the computing device or by an application running at the computing device. The application may be accessed via World Wide Web (WWW) such as the Internet.

As used herein the term “money flow input” can include money transaction related information that may be entered by a user or received from a third party unit. The “money flow input” may include budget amount, expense, saving amount etc. The term “third party unit” refers to a bank, shopping store or similar with which the user does a financial transaction.

Further, the term “financial transaction” may include any transaction involving receiving or giving money in form of cash, credit, a bank cheque, and so forth. The term “financial event” may include events related to payment or receiving of money. The financial event may include a bill payment due date reminder, payment received notification. The financial event may happen on a particular date of a particular month.

The term “budget threshold value” can refer to a fixed predefined numeric value set by a user or like for managing his/her expenses in a particular time frame for example a day, a week, a month, a year, and so forth. The budget threshold value may be include a currency value, e.g., USD, INR, EUR, GBP, and so forth.

The computing device or system for facilitating a user to manage his/her personal finances such as, budget, project, money flow, and so forth may be a software, hardware, firmware, or combination of these. The computing device or the system is further intended to include or otherwise cover all software or computer programs capable of performing the various heretofore-disclosed determinations, calculations, etc., for the disclosed purposes. For example, exemplary embodiments are intended to cover all software or computer programs capable of enabling processors to implement the disclosed processes. Exemplary embodiments are also intended to cover any and all currently known, related art or later developed non-transitory recording or storage mediums (such as a CD-ROM, DVD-ROM, hard drive, RAM, ROM, floppy disc, magnetic tape cassette, etc.) that record or store such software or computer programs. Exemplary embodiments are further intended to cover such software, computer programs, systems and/or processes provided through any other currently known, related art, or later developed medium (such as transitory mediums, carrier waves, etc.), usable for implementing the exemplary operations disclosed below.

In accordance with the exemplary embodiments, the disclosed computer programs can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from the memory on the computing device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), personal area networks (PANs), storage area networks (SANs), home area networks (HANs), campus area networks (CANs), local area networks (LANs), metropolitan area networks (MANs), virtual private networks (VPNs), enterprise private networks (EPNs), global area networks (GANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

Overview:

Embodiments of the present disclosure relate to methods, devices, systems, apparatus, computers and computer readable mediums, and graphical user interfaces that can facilitate a user to manage his/her personal finances conveniently using his/her computing device. The computing device may include a finance management system for facilitating the user to manage his/her finances, projects, budgets, and so forth. The finance management system may be a software application installed on the computing device. In some embodiments, the finance management system may be a web based system that the user can access via a web site using the Internet or any suitable network. The GUI is displayed at the computing device. The GUI includes a number of finance management options such as options for managing “Daily Budget”, “Monthly Budget”, “Net Worth”, “Reconcile”, and so forth. The user can select at least one of the finance management options for managing his/her money flow etc. Based on the selection, the user may be requested for more money flow inputs. The finance management system generates a pictorial representation based on the selection of the at least one finance management option and the money flow inputs. The pictorial representation may be displayed to the user. The pictorial representation may include a node and multiple sub nodes attached to the node through one or more connectors. The user can interact with the pictorial representation on the GUI and may manipulate the one or more of the node and the sub nodes. Further, each of the node and the sub nodes includes a financial indicator having one or more colors based on a budget threshold value or other conditions. Further, the connectors are shown using different colors that may also change based on the budget threshold value or other conditions. The user can review the pictorial representation and can also modify a value associated with the node and the sub nodes.

### Exemplary Embodiments

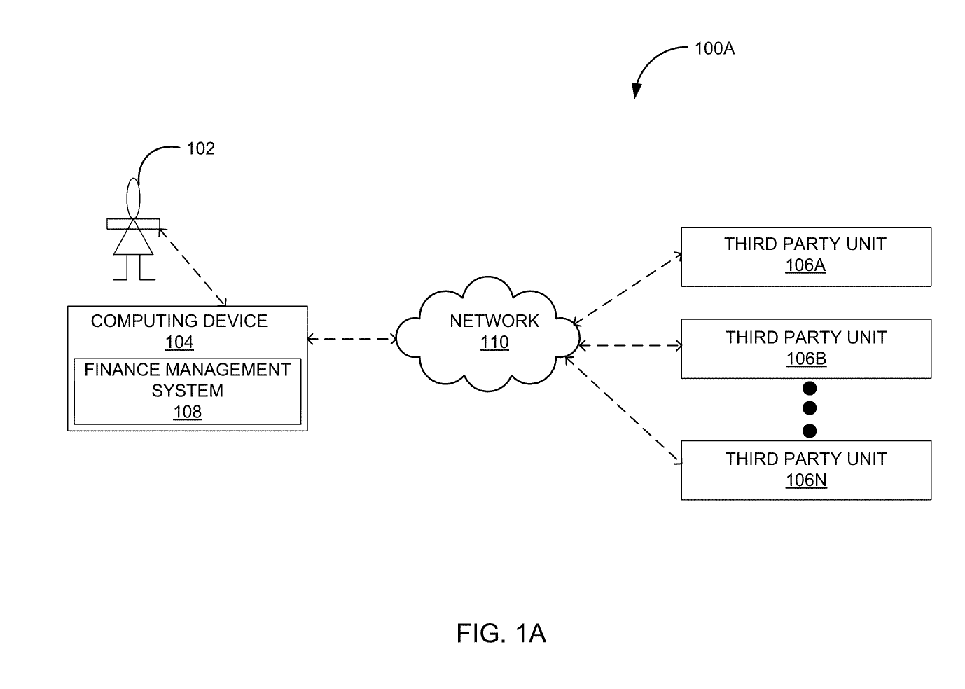

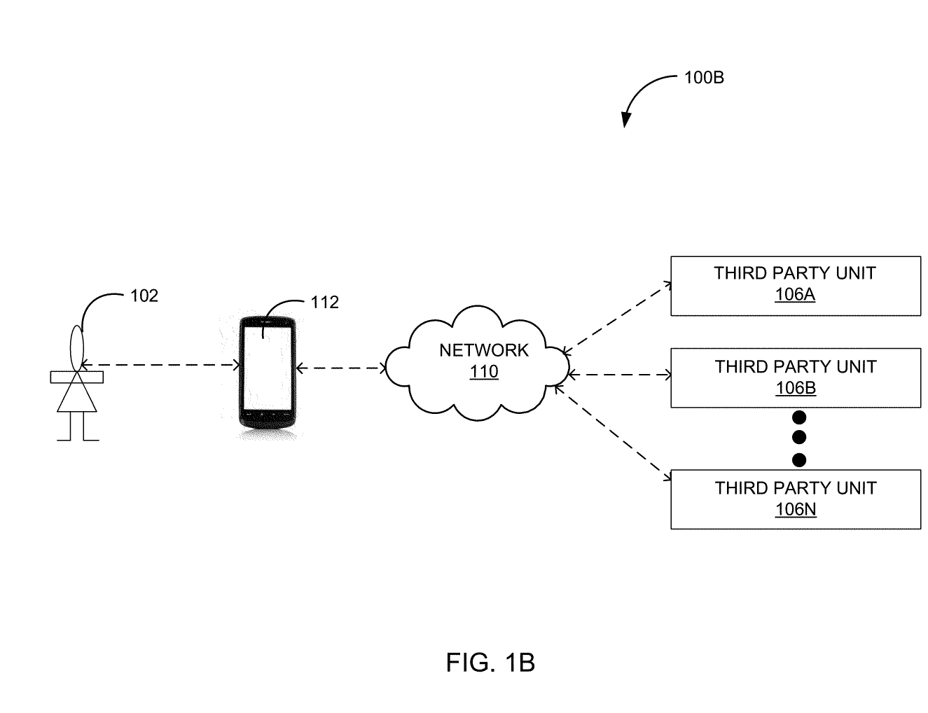

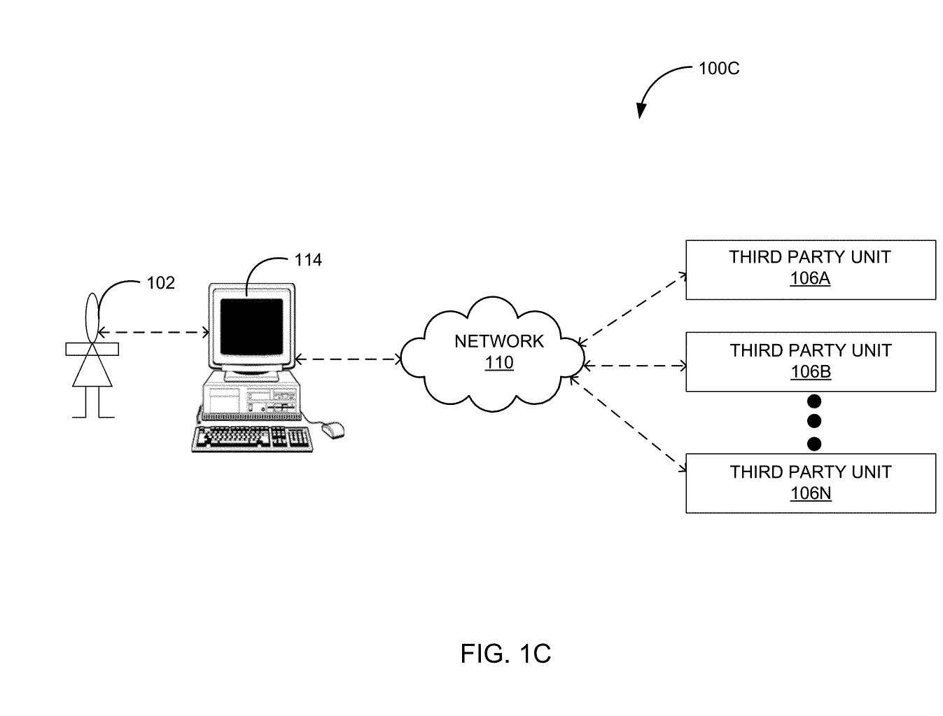

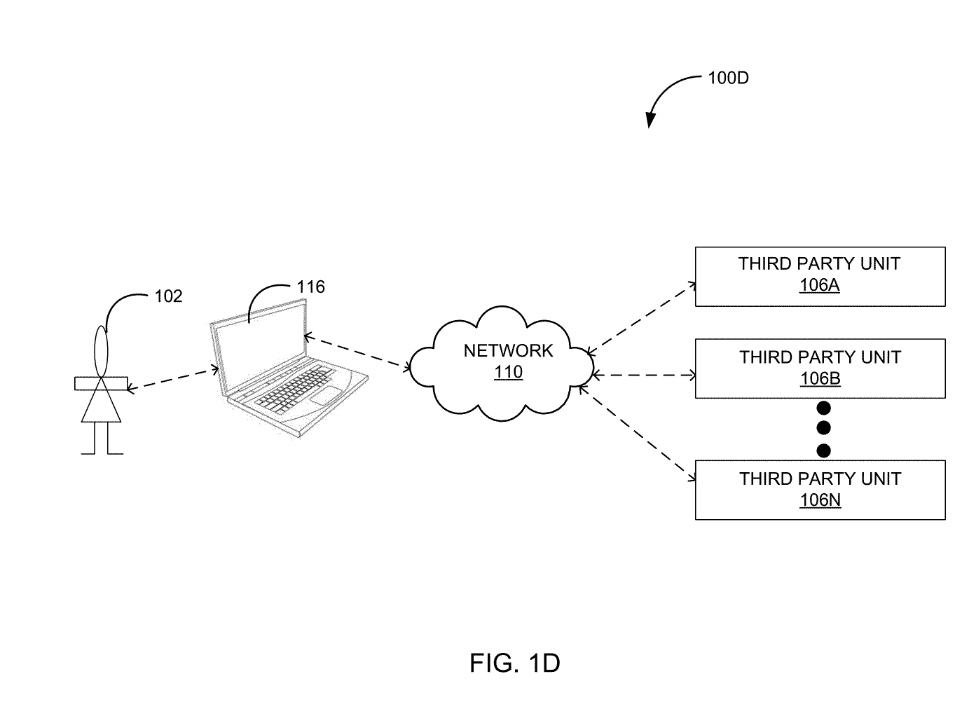

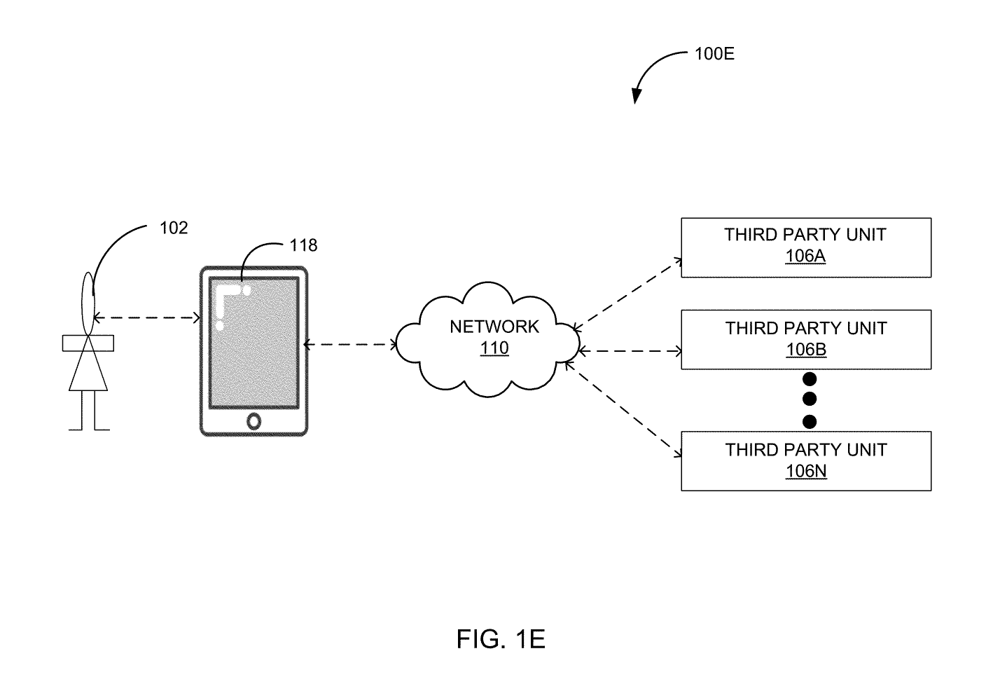

FIG. 1A-1E are schematics that illustrates exemplary system 100A-100E, in accordance with various embodiment of the present disclosure. To analyze the present disclosure, the system 100A can be visualized as having the following primary components, a user 102, a computing device 104, and a number of third party units 106A-106N capable of sending information to the computing device over a network 110. The computing device 104 further includes a finance management system 108. The user 102 can access the finance management system 108 on the computing device 104. The finance management system 108 may be a software application, hardware, firmware or a combination of these. In some embodiments, the user 102 can access the finance management system via the Internet by entering a Uniform Resource Locator (URL) on a web browsing application. The computing device 104 can be such as, but are not limited to, a mobile phone 112, a desktop computer 114, a laptop computer 116, a tablet computer, a personal digital assistant (PDA), and so forth as illustrated in FIG. 100B-100E.

The finance management system 108 can also receive one or more financial transaction related information from the third party units 106A-106N, such as banking institutions, shopping stores, and so forth through the network 110.

The finance management system 108 can display a graphical user interface (GUI) on a display of the computing device 104. The GUI may include a number of finance management options that allow the user 102 to manage his/her finances, budgets, projects, and so forth. The user 102 can select one or more of these finance management options. Based on the selection, the finance management system 108 may request one or more money flow inputs from the user 102. Post receiving the money flow inputs, the finance management system 108 may generate a pictorial representation and display at the display device of the computing device. The user 102 is allowed to interact with the pictorial representation.

The pictorial representation may include at least one node and a number of sub nodes associated with the node. The sub nodes may remain connected to the at least one node via one or more connectors. The node and the sub nodes may be represented as bubbles, branches of the tree, circles, squares, or any suitable shape or image. Further, the node and the sub nodes may include an associated value e.g. currency value. The values can be represented as energy flow, and may be shown as alive and moving up and down within the node, and sub nodes. The sub nodes may be represented using different colors and energy levels (financial indicators). For example, the currency in the node may be represented by “Green” when flowing, and “Brown” when stagnate, ‘Yellow” when attention of the user 102 is required, “Red” when the user 102 exceeds the budget, and “Blinking Red” when immediate action is required. Further, the color and energy level in the sub nodes may change, blink, expand, or contract based on state of the category, currency in the sub node. The pictorial representation is described in detail with reference to subsequent figures.

Further, the GUI may be dynamic and may change based on one or more entries related to expenses, assets, liabilities, purchases etc. of the user 102 in real time. Furthermore, the GUI may be developed using any suitable and appropriate design application, for example, but not limited to, Photoshop, Illustrator, and so forth.

The finance management system 108 can also receive one or more financial transaction related information from the third party units 106A-106N, such as banking institutions, shopping stores, and so forth through the network 110.

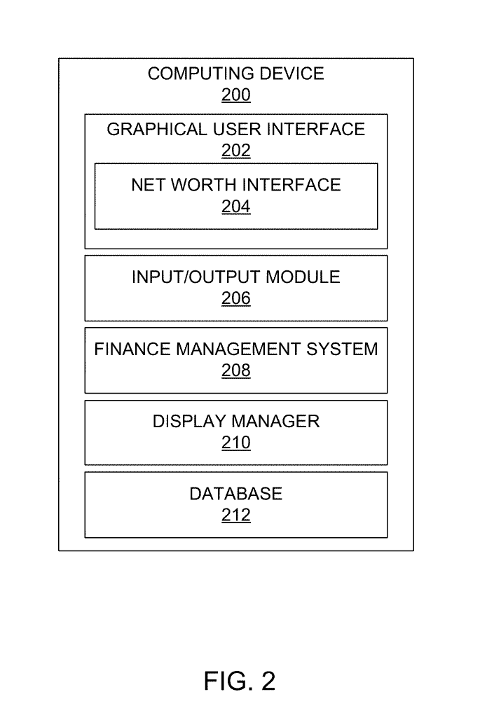

Further, the user 102 can review the one or more node and sub nodes of the pictorial representation. The structural components of the computing device 104 are described in detail with reference to FIG. 2.

FIG. 2 is a schematic illustrating structural components of the computing device 104 for facilitating the user 102 to manage his/her personal finances, budgets, projects, and so forth, in accordance with an embodiment of the present disclosure. As discussed with reference to FIG. 1A-1E, the user 102 can interact with the computing device 104. The computing device 104 includes a graphical user interface (GUI) 202, an Input/Output (IO) module 206, a finance management system 208 (similar to the finance management system 108), a display manager 210, and a database 212.

The GUI 202 includes a number of finance management options in form of icons, text, or images. The user 102 can select at least one of the finance management options for managing his/her finances. Examples of the finance management options include, but are not limited to, options for “Daily Budget”, “Monthly Budget”, “Net Worth”, and “Reconcile”. The GUI may also include one or more options including, such as, but not limited to, “tutorials”, “Profile”, “Community”, “Credit Score”, “Contact Us”, “Resources”, and so forth. The user 102 can select at least one of the finance management options based on his/her finance management requirement. For example, if the user 102 wants to manage his daily budget, the user 102 may select the “Daily Budget” option. Further, the user 102 is allowed to select at least one of the one or more options. The GUI 202 may also include a Net Worth Interface 204 that may be displayed to the user 102 when the user 102 selects the “Net Worth” finance management option. The Net Worth Interface 204 may further include additional finance management options. Further, the GUI 202 may change its appearance based on the selection of at least one of the finance management options or the one or more options displayed as part of the GUI 202.

The IO module 206 is configured to receive the selection of the finance management options and of the one or more options from the user 102. The IO module 206 is also configured to request and receive one or more money flow inputs from the user 102 based on the selection of the at least one finance management options by the user 102.

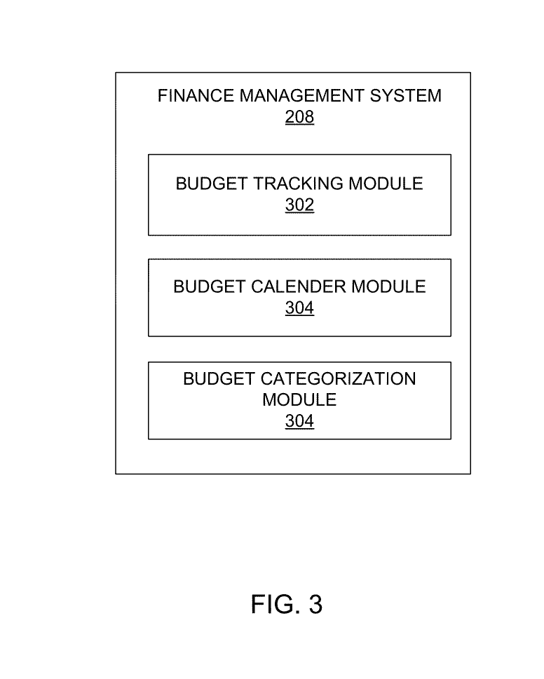

The finance management module 208 further comprises one or more modules and is described in detail with reference to FIG. 3. The display manager 210 is configured to display the GUI 202 at the computing device 204. The database 212 is configured to store and maintain details about various finance related transactions of the user, profile of the user, and so forth. Further, the database 212 is configured to store the one or more money flow inputs received from the user 102, and pictorial representations. The computing device 104 is also configured to receive one or more information from the third party units 106A-106N as shown in FIG. 1A. The third party units 106A-106N may include banking institutions, shopping stores, service stations, and so forth. The third party units 106A-106N may send information such as information related to financial transaction of the user 102 to the computing device 104. The IO module 206 at the computing device 104 is configured to receive or send the information from the third party units 106A-106N.

Moving now to FIG. 3, the finance management module 208 includes a budget tracking module 302, a budget calendar module 304, and a budget categorization module 306. It should be understood to a person ordinarily skilled in the art that the finance management module 208 might include more or less number of modules, without limiting the scope of this invention disclosure.

The budget tracking module 302 also allows the user 102 to see income, deposits and set and make check payments for a particular budget period on particular bill payment dates. In some embodiments, the budget tracking module 302 may notify the user 102 about a purchase or expense when the user 102 steps out of a shopping store in form of a tone or short messaging service (SMS) message or email. This may notify the user 102 that the budget tracking module 302 has been notified of a purchase. After finishing the shopping, the user 102 may access the finance management system 208 or application on his/her mobile phone or any suitable computing device. The finance management system 108 may display a purchase tracker, including details about various purchases made by the user 102, to the user. The user 102 can view the shopping stores he/she visited and amount of money, if any he/she spent at each of the stores. This information may be represented as multiple line items to the user 102. In some embodiments, the budget tracking module 302 may categorize the line items into different existing or new categories or sub nodes. In alternative embodiments, the user 102 may manually categorize the line items by touching and dragging and dropping the item into one or more categories or sub nodes.

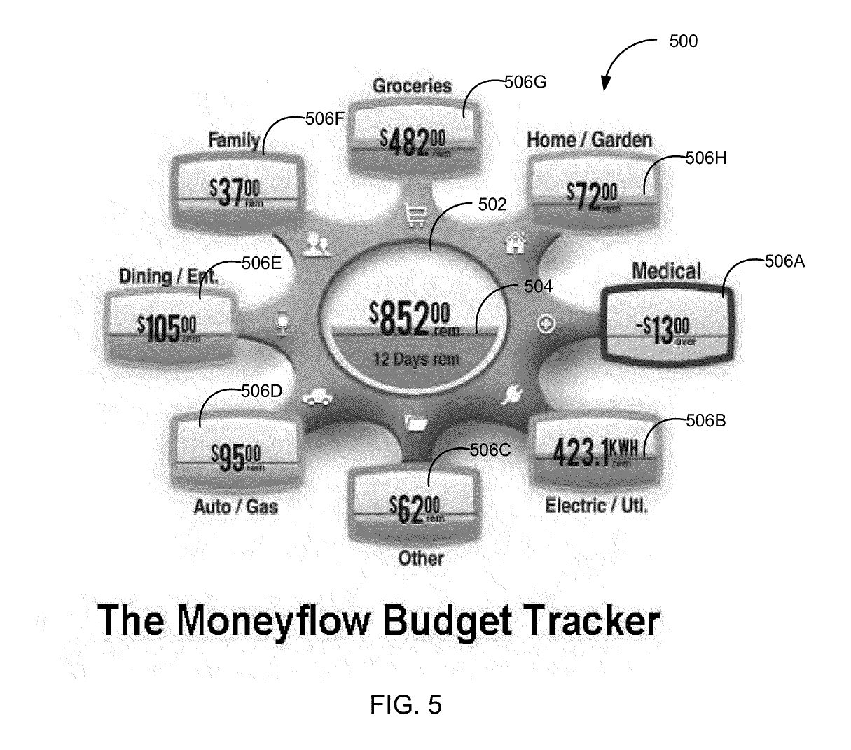

The budget tracking module 302 is configured to keep a track of various financial transactions of the user 102. The budget tracking module 302 is also configured to generate a pictorial representation (See 500 in FIG. 5) based on the selection of the finance management options and/or one or more money flow inputs received from the user 102. The pictorial representation may include a node and a number of sub nodes. In some embodiments, the pictorial representation may include more than one node. The sub nodes may remain connected to at least one node through one or more connectors or connecting lines. The connectors may be represented using one or more colors that may vary depending on one or more conditions. Each of the node, one or more sub nodes may have an associated value. The value may be provided in form of days remaining in a budget period or budget cycle, $ (currency) remaining in the overall budget, and categories. The color of the connectors (or channels) may represent the “Budget Green” by color and the frequency the “Budget Threshold Value” as the liquid energy (or financial indicator) within the node and the sub nodes varying based on their deviation from the “Budget Threshold Value” (or “Budget Benchmark”).

The financial indicator may change in color, frequency, and level based on conditions such as when the remaining dollar ($) amount in the representative pool deviates from the “Budget Threshold Value”. In an exemplary scenario, at the “Budget Threshold Value”, the color and frequency of the liquid energy flow is “budget green”, and the level is exactly half-full. When the amount ($) approaches within 0.05 and beyond One standard deviation (1SD) the color changes to “canary yellow” and level equals (−1SD) ⅜ or (+1SD) ⅝ full in the sub nodes or node. When the amount ($) approaches from 0.05 and beyond 2 standard deviations the color may become “notification red” and the level may equal to (−2SD) ¼ or (+2SD) ¾ full.

Further, in the pictorial representation, “%” represents the dollar remaining in the budget (sub node) divided by the associated “Budget Threshold Value”. At 100%, the user 102 is 100% on track of the established budget, above “Budget Threshold Value” is indicated above 100% of the category (sub node) is beyond and below 100% of the category is behind or below the “Budget Threshold Value”. The “Budget Threshold Value” may be generated based on a historical data or forecast through a plan, goal or evaluation. The historical data may be stored in the database 212.

The pictorial representation may provide a real time visual indication to the user 102 to view how the user 102 is doing within each category (sub node) of your budget. Further, this may make it easy for the user 102 to stay on track with the budget that the user may have established initially. Further, the user 102 may review his/her expenses by viewing the pictorial representation. The user 102 can have a second look at their spending from the perspective of their established budget and their financial goals. As the user 102 may engage in the finance management system 108 (or 208), this new perspective takes hold and the user 102 may begin to make more thoughtful purchasing decisions.

Further, the pictorial representation and the finance management system 108 may guide the user 102 to establishing financial goals based on their personal or family requirement and dreams. In addition, the pictorial representation may make it easy for the user 102 to maintain strong emotional connection with the goals. Further, the payoff for the user 102 may occur during the Monthly Review (by the user 102) as the user 102 allocates the cash flow he/she has accrued through the month toward the advancement of their financial goals. The emotional connection, the user 102 makes as they advance their financial goals provide encouragement for the user 102 to make good spending decisions, find savings options, and increase the amount of cash flow that the user 102 may have at the end of the following month.

Further, the budget tracking module 302 allows the user 102 to enter or define a predefined budget threshold value. For example, the user 102 may decide to have a monthly budget of USD 2500, and then the user 102 may define the budget threshold value as USD 2500. Further, the budget tracking module 302 may allow the user to set or enter values using currency of his/her own country. The display manager 210 may display the pictorial representation at the computing device 104. Further, the user 102 is allowed to manipulate the at least one of the node and the one or more sub nodes. The user 102 may manipulate the node(s) and the sub nodes by selecting and dragging the at least one of the node and the one or more sub nodes. The node and the one or more sub nodes are represented using a plurality of colors depending on a predefined budget threshold value. Further, the one or more connectors include one or more colors. The one or more colors of the one or more connectors may vary depending on the predefined budget threshold value.

Further, each of the node and the one or more sub nodes may include at least one financial indicator. The at least one financial indicator may include multiple colors. The at least one financial indicators may provide finance related indication to the user 102, such as, but not limited to, a statistical deviation from the predefined budget threshold value, a percentage of budged remaining based on the predefined budget threshold value, an amount remaining in a budget period, and number of days remaining in the budget period. Further, the node may be corresponding to a main subject matter, and the one or more sub nodes may be corresponding to one or more categories associated with the at least one node. Further, each of the node and the sub node may represent a numeric value corresponding to one or more categories, for example, expenses, purchases, grocery items, fees, bills, assets, credit, debt, and so forth. The value of each of the node, or sub nodes may keep on changing with time depending on spending, savings etc. of the user 102. The node and the sub nodes may change level or colors accordingly.

Further, the finance management system 208 may utilize a “Freemium” business model with advertisements in form of the saving options, premium editions and financial services. The GUI 202 may include the advertisements, saving options, etc. The saving options in form of deals, offers, discounts, and coupons may be presented to the user 102 on the GUI 202, as the user 102 engages in specific financial transactions. For example, the user 102 is reviewing the details of his/her grocery budget, and then grocery-related saving options may be displayed on the GUI 202. The display manager 210 may display the advertisements, saving options, deals, and so forth on the GUI 202 of the computing device 104. In an exemplary scenario, when the user 102 is determining their Insurance budget for the month, insurance-related advertisements may be displayed to the user 102. The premium options may include Independent Contractor, and Small Business Editions options and suggestions for the user 102. Examples of the financial services may include using an index stored in the database 212 of the finance management system 208 to refer refinancing, loan, and mortgage services as well as tax refund.

The budget calendar module 304 is configured to allow the user 102 to access a calendar including one or more financial events. The user 102 is also allowed to set and check payments for the budget period.

The budget categorization module 306 may categorize a number of financial transactions into a number of categories.

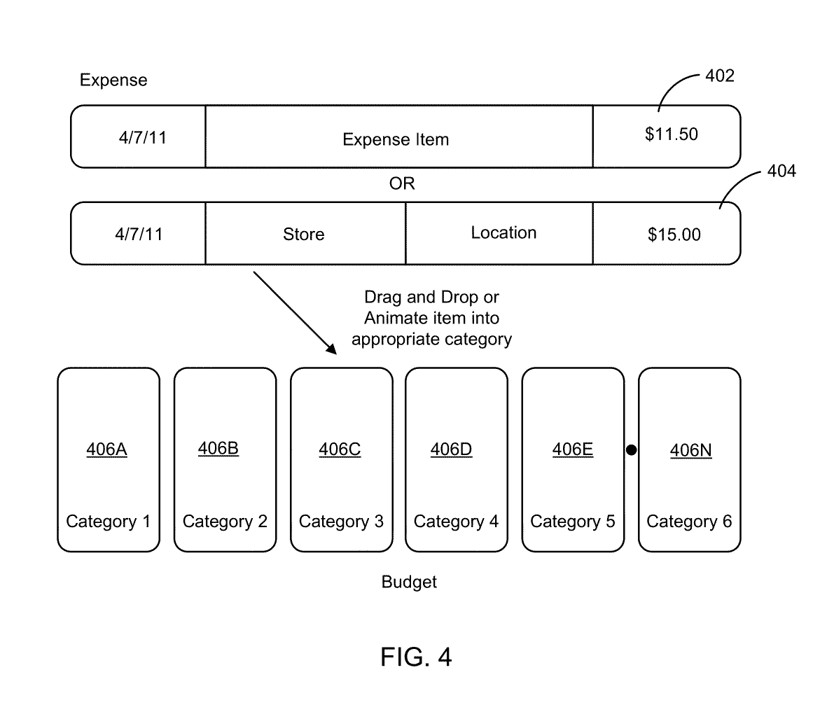

Turning now to FIG. 4, the user 102 may review the pictorial representation displayed at the computing device 104. FIG. 4 is a schematic illustrating an exemplary process of updating expenses and purchases into one or more categories, in accordance with an embodiment of the present disclosure.

The user 102 may further organize their expenses 402 and purchases 404 via the processes of dragging and dropping or view the animation of their expense 402 moving into appropriate category 406A-406N (or budget category) as shown in FIG. 4. Once the expense is dropped into the appropriate category 406A-406N, the category 406A-406N may indicate a change in the currency (such as INR, USD etc.) amount remaining in the node or sub nodes corresponding to the modified category in the pictorial representation.

The expense item or expense 402 may be entered by the user 102 by drag and drop or may be received from one or more of the third party units 106A-106N directly. The budget tracking module 302 is also configured to perform financial aggregation of the received and entered data. The data entry may also happen based on one or more photo receipt with camera or through any other form of digitized receipt. In some embodiments, the budget tracking module 302 may aggregate the financial data using bank level security, and may present the aggregated data to the user 102 via GUI's tools that are intuitive and easy to understand.

The finance management system 208 may engage the user 102 in a simple, powerful, game-like step to control their cash flow and a second powerful, game like step to building their net worth. These powerful, games like steps can be performed from either a web or mobile device and may give the user 102 a visceral understanding of their personal finances.

FIG. 5 is a schematic illustrating an exemplary pictorial representation 500 including one node, in accordance with an embodiment of the present disclosure. As shown, a node 502 is corresponding to a subject matter such as monthly budget. The one or more sub nodes may be corresponding to one or more categories or aspects associated with the at least one node 502. The node 502 and the sub nodes 506A-506N may be represented as bubbles, branches of the tree, circles, squares, or any suitable shape or image. Further, the node 502 and the sub nodes 506A-506N may include an associated value e.g. currency value. The values can be represented as energy flow, alive and moving. The sub nodes 506A-506N may be represented using different colors and energy levels (financial indicators). In an exemplary scenario, the currency in the node 502 may be represented by “Green” when flowing, and “Brown” when stagnate, ‘Yellow” when attention of the user 102 is required, “Red” when the user 102 exceeds the budget, and “Blinking Red” when immediate action is required.

Further, the color and energy level in the sub nodes 506A-506N may change, blink, expand, or contract based on state of the category, currency in the sub nodes 506A-506N. Further, the sub nodes 506A-506N indicate categories associated with the subject matter, here monthly budget, of the node 502. The sub nodes 506A-506N may also indicate $ (or currency) remaining in the budget period, and the % of spending in that budget category that is on track for the budget period. The one or more of the sub nodes 506A-506N may turn “Yellow” when the user 102 has gone below 75% of budgeted funds to days remaining. If one or more of the sub nodes 506A-506N turns “Red”, this indicates that the user has exceeded budgeted funds for that budget period. When one or more of the sub nodes 506a-506N blink “Red”. This indicates action is required to make payment by putting a check in the mail or by funds transfer. The colors and blinking conditions described above is for exemplary purpose of describing the invention, a person skilled in the art will appreciate that any colors or conditions may be used for the node 502 and the sub nodes 506A-506N.

The pictorial representation 500 includes the monthly budget node 502 with value of $852 and includes a financial indicator 504 representing number of days remaining or budget period remaining. The pictorial representation 500 also includes a number of sub nodes 506A-506N. As shown, the node 502 and the sub nodes 506A-506N may have a different color. Further, each of the sub nodes 506A-506N may have a different color.

Further, the pictorial representation 500 may provide a measure at the node 502 and sub nodes 506A-506N, in the form of $ amount (or any suitable currency unit) remaining in the budget cycle and a % of money (flow) remaining in at least one of the sub nodes 506A-506N in relationship to the total amount budgeted in a budget cycle. In addition, the pictorial representation 500 may include a “Budget Threshold Value” (or Budget Benchmark), which indicates the expected amount of money that should be remaining in the pool at this date in the budget cycle. In an exemplary scenario, the “Budget Threshold Value” (or Budget Benchmark) may be calculated using the below formula 1:

Budget Threshold Value=Total $ Budgeted−(No. of days into the budget*Daily Budget)

The “Daily Budget” may be defined or set using formula 2 shown below:

Daily Budget=Total $ Budgeted/No. of days in Budget Cycle

By specific dates, $ amount associated with fixed payment items may also be considered while setting the daily budget. In some embodiments, the user 102 may set the “Daily Budget” and the “Budget Threshold Value”. Further, as shown the color in the node 502 or the sub nodes 506A-506N may change depending on the amount of money remaining in the category associated with the sub nodes 506A-506N in relationship to the “Budget Threshold Value” (or Budget Benchmark).

Further, each of the one or more sub nodes 506A-506N includes a financial indicator similar to the financial indicator 504. The at least one financial indicator 504 may include a number of colors. Further, the colors of the financial indicator(s) 504 varies based on the predefined “Budget Threshold Value”. The financial indicator(s) 504 may indicate a statistical deviation from the predefined budget threshold value, a percentage of budged remaining based on the predefined “Budget Threshold Value”, an amount remaining in a budget period, and number of days remaining in the budget period

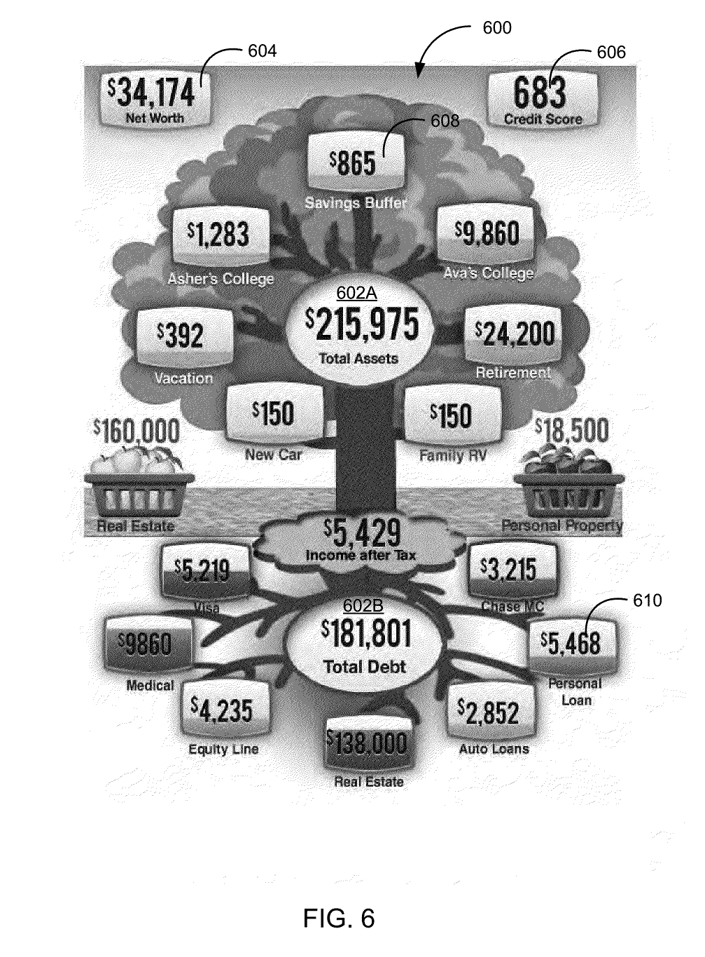

FIG. 6 is a schematic illustrating another exemplary pictorial representation 600 including two nodes 602A-602B, in accordance with another embodiment of the present disclosure. The pictorial representation 600 depicts a dual node Net Worth Interface 600. Herein after, the Net Worth Interface 600 may be referred as the pictorial representation 600 without changing its meaning or functionality. The net worth interface 600 allows the user 102 to manage his/her assets and or debts. The nodes 602A-602B are related to two associated subject matters. The node 602A has its associated sub nodes 608, and the node 602B may have its associated sub nodes 608. The pictorial representation may also include sub nodes 604-606. In the net worth interface 600, the nodes 602A-602B represents Assets and Liabilities (or Debt), respectively.

The pictorial representation 600 or 500 may be generated for project management too. In some embodiment, a pictorial representation for the project management, the overall project (or projects) may be represented by a node and the associated categories may be represented by sub nodes (similar to 506A-506N).

Similarly, an organization management pictorial representation may also be generated by the finance management system 208. In the pictorial representation for organizational business management, overall organization may be represented as a node and different department of the organization may be represented as sub nodes.

In some embodiments, for personal management of the user 102, the finance management system 208 may generate a personal management pictorial representation where overall balance of the user 102 is represented as a node and the aspects of the user 102 may be represented as the sub nodes. The aspects of the user 102 may include physical aspect, mental aspect, spiritual aspect, family aspect, work aspect, and so forth.

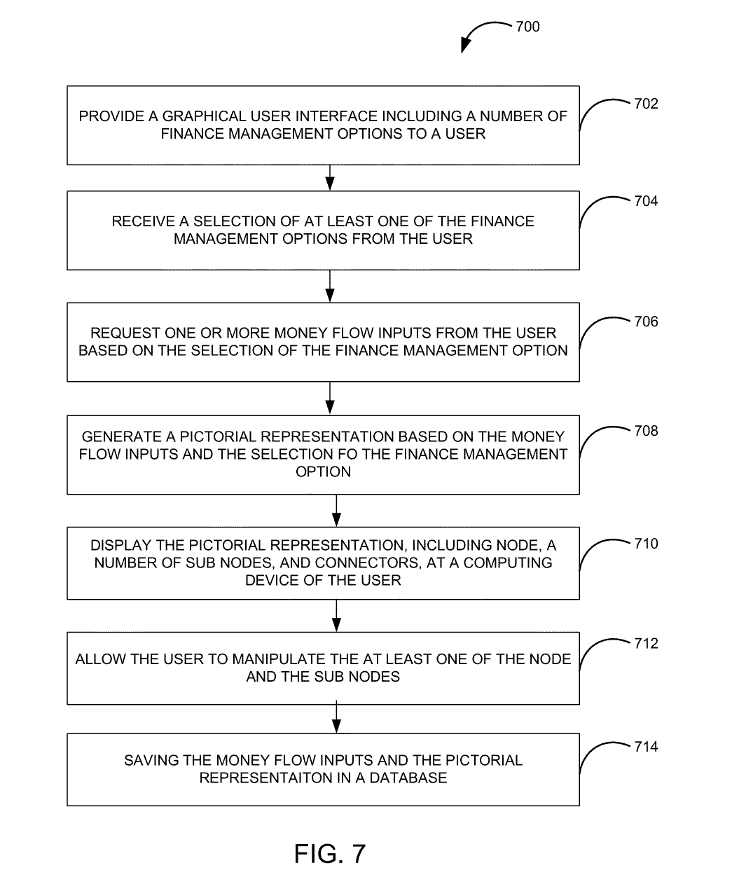

FIG. 7 is a flowchart illustrating a method for facilitating the user 102 to manage his/her personal budget, in accordance with an embodiment of the present disclosure. As discussed with reference to FIGS. 1A, 2, and 3, the user 102 can access the finance management system 108 on his/her computing device 104 as an installed application or a web based solution via the Internet or any suitable network. The finance management system 108 can also receive one or more financial transaction related information from the third party units 106A-106N, such as banking institutions, shopping stores, and so forth through the network 110.

At step 702, a graphical user interface (GUI) is provided to the user 102. In some embodiments, the GUI is provided by the display manager 210 at a display device associated with the computing device 104. The GUI may include a number of options including one or more finance management options. The GUI may also include advertisements, financial advises for the user 102, and so forth. The finance management options may include, but are not limited to, options for managing “Daily Budget”, “Monthly Budget”, “Net Worth”, “Reconcile”, and so forth. The user 102 can select at least one of the finance management options to manage his/her monthly budget, daily budget, net worth and so forth.

At step 704, the IO module 206 receives a selection of the at least one finance management option from the user. Then at step 706, the IO module may request one or more money flow inputs from the user 102 based on the selection of the at least one finance management option.

Further, at step 708, the budget tracking module 302 may generate a pictorial representation including at least one node corresponding to a subject matter and one or more sub nodes corresponding to one or more categories associated with the subject matter. The sub nodes may remain connected to the node via one or more connectors having a specific color. The pictorial representation may be generated based on the selection of the at least one of the finance management options and the one or more money flow inputs. Thereafter, at step 710, the pictorial representation is displayed to the user 102. In some embodiments, the display manager 210 may display the pictorial representation at the display device associated with the computing device 104.

The method continues at step 712, the user 102 is allowed to interact with the pictorial representation and/or manipulate one or more of the node and the sub nodes. At step 714, the money flow inputs and pictorial representation is saved in the database 212. The database 212 may also maintain profile and contact information about the users such as the user 102 and also about various third party units 106A-106N. The user 102 can review the pictorial representation and may modify the value in one or more of the node and the sub nodes.

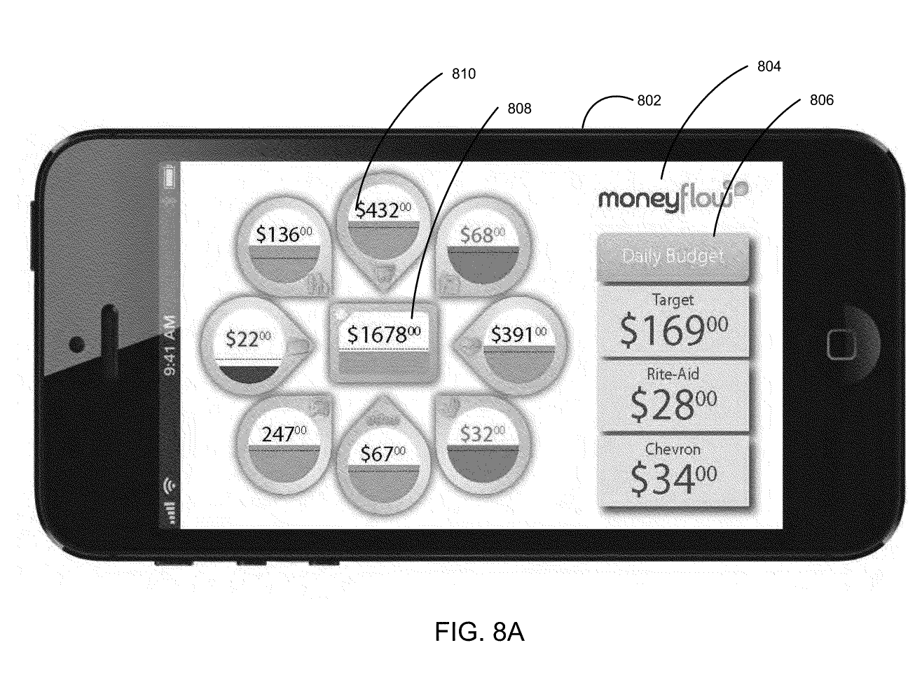

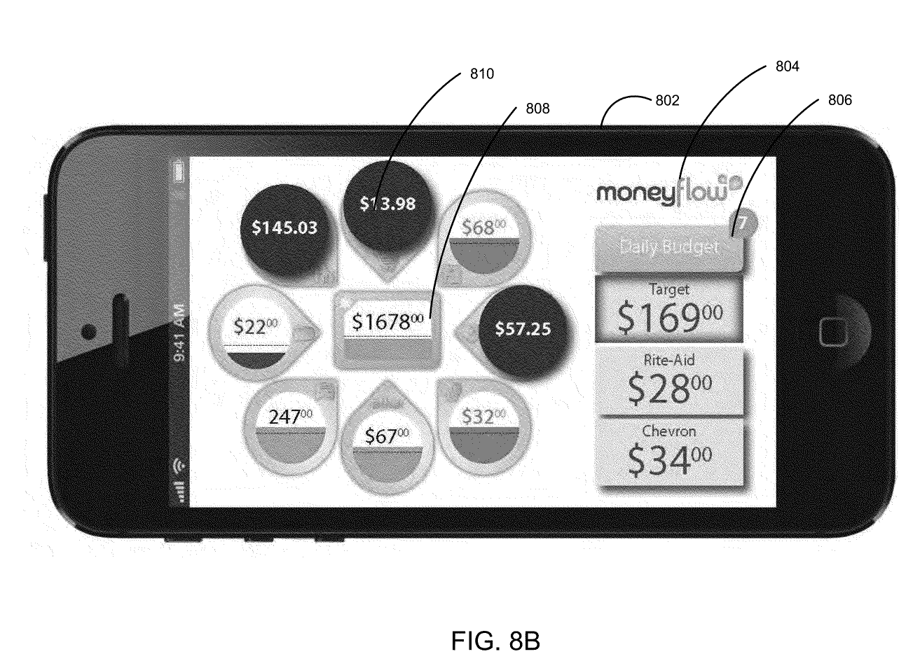

FIGS. 8A-8B depicts a snapshot of a GUI 804 of a finance management system running on a mobile phone 802, in accordance with an embodiment of the present disclosure. As discussed with reference to FIGS. 1A-1B, 2, and 3, the user 102 can access a finance management system or application similar to the finance management system 108 on the computing device 104. The display manager 210 may provide the GUI 804 when the user 102 accesses the finance management system or application. The GUI includes a number of finance management options, such as a Daily Budget option 806. The GUI 804 includes a pictorial representation including a node 808 and a number of sub nodes 810. Each of the node 808 and the sub nodes 810 may include a financial indicator in form of a level indicator within each of the node 808 or sub nodes 810 etc.

Further, each of the node 808 and the sub nodes 810 has an associated value that may be shown as a numeric value, a graph, an image, and so forth. The mobile phone 802 may be a smart phone. Further, in some embodiments, the mobile phone 802 is connected to a network and is capable of receiving data from one or more third party units, such as the bank, etc.

Further, the financial indicator may go up or down as the time passes and based on user spending etc. In addition, the color of the node 808 or the sub nodes 810 may also change as the value of the node or the sub nodes fall below a predefined Budget Threshold Value. FIG. 8B shows this change is color or level of the financial indicator of one or more sub nodes.

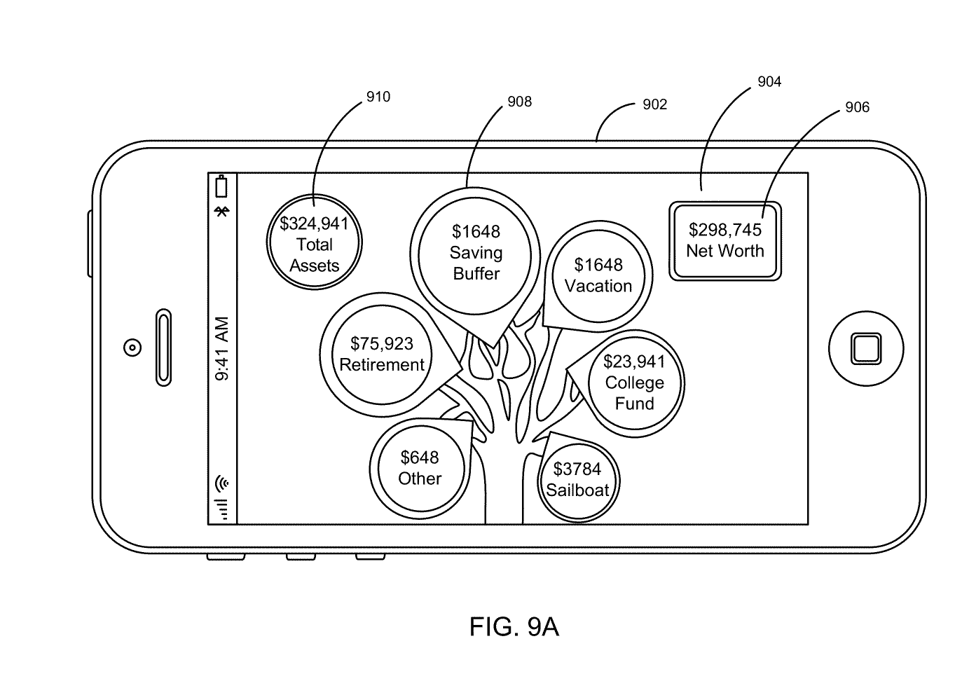

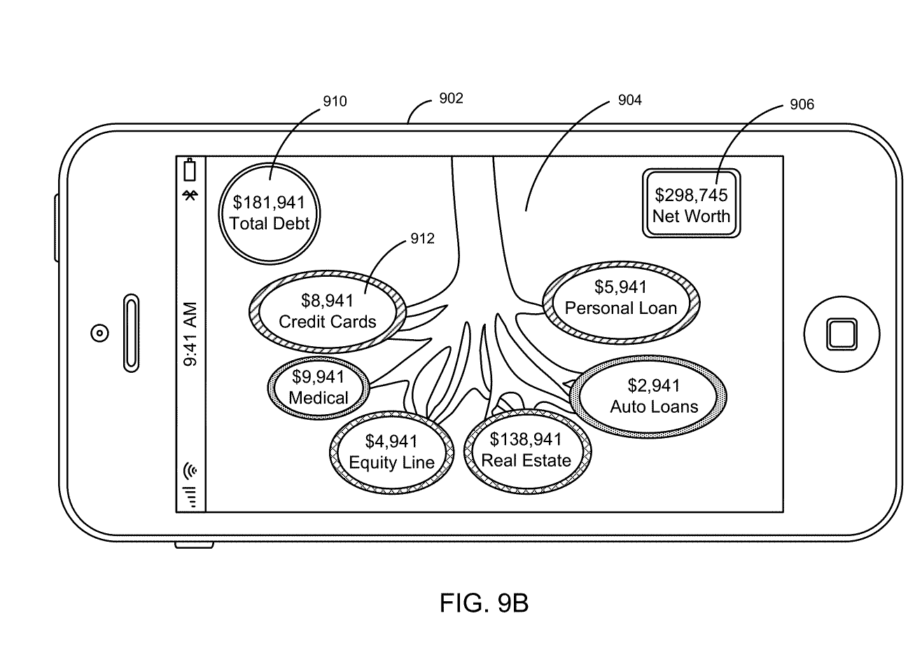

FIGS. 9A-9B illustrates a snap shot of a Net Worth Interface 904 on a mobile phone 902, in accordance with an embodiment of the present disclosure. The Net Worth Interface 904 includes nodes 910 and 906, a number of sub nodes 908. It should be appreciated that though the Net worth interface 904 is shown in form of a tree and node 910, node 906 and sub nodes are shown as leaves, but any image may be used to depict the same. For example, the node, sub nodes may be shown as pool, bubble, circle, and so forth. When the finances of the user are in control, the node 906, 910 and sub nodes 908 may be displayed using “green” color or any suitable color.

FIG. 9B shows a snap shot of the Net Worth Interface that changes over a period of time depending on value within the nodes 906, 910 and sub nodes 908. As shown, the tree is displayed as upside down and color of the nodes 906, 910 and sub nodes 908 may also change to “red” etc.

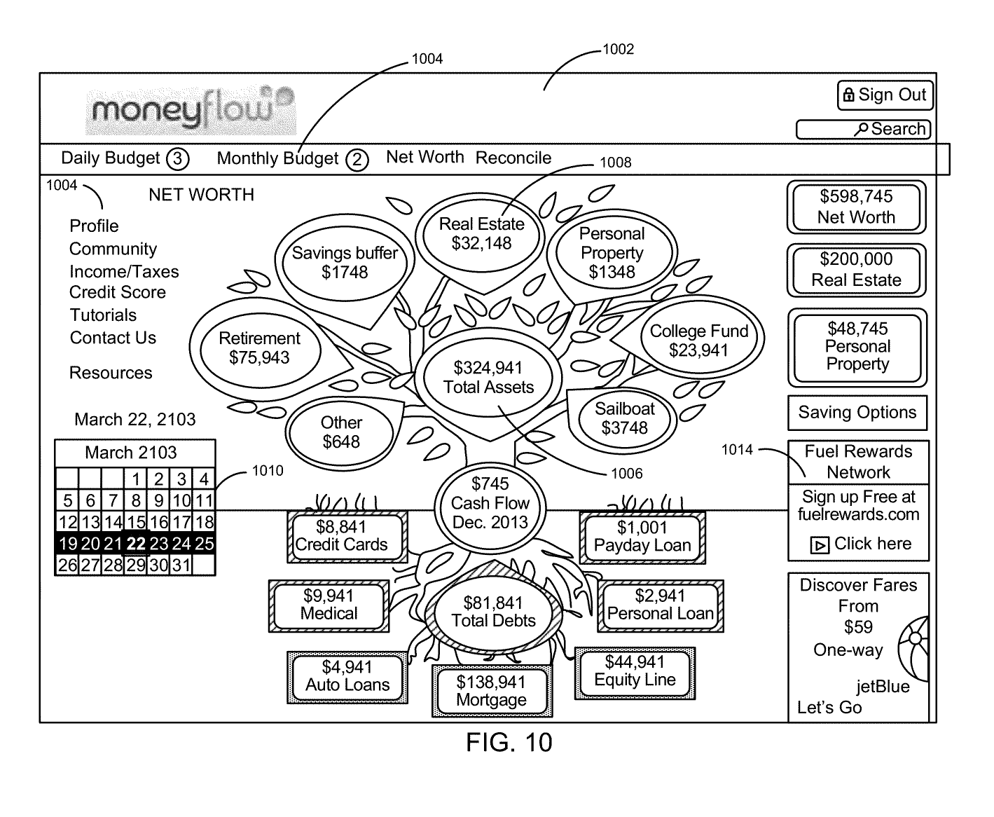

FIG. 10 illustrates a snap shot of a GUI 1002 (or a money flow interface) of a web based finance management system, in accordance with an embodiment of the present disclosure. As discussed with reference to FIG. 1A, the user 102 can access the finance management system via the Internet. The GUI 1002 includes one or more finance management options 1004. The finance management options 1004 may include options such as, but not limited to, “Daily Budget”, “Monthly Budget”, “Net Worth”, and “Reconcile”. The GUI 1002 may also include one or more options 1012 such as, but not limited to, “Profile”, Contact”, “Community”, “Tutorials”, “Credit Score”, “Resources”, “Income/Taxes”, and so forth. As shown, the GUI 1002 includes a pictorial representation including two nodes 1006 representing “Total Assets” and “Total Debts”. Both the nodes 1006 may be shown using different color to give a better visual indication to the user 102. The GUI 1002 may also include a budget calendar highlighting a number of financial events in a particular time like in a month.

The finance management system may utilize a “Freemium” business model with advertisements in form of the saving options, premium editions and financial services. The GUI 1002 may include the advertisements, saving options 1014, etc. The saving options 1014 in form of deals, offers, discounts, and coupons may be presented to the user 102 on the GUI 1002, as the user 102 engages in specific financial transactions. For example, the user 102 is reviewing the details of his/her grocery budget, and then grocery-related saving options may be displayed on the GUI 1002. The display manager 210 may display the advertisements, saving options, deals, and so forth on the GUI 1002 of the computing device 104. In an exemplary scenario, when the user 102 is determining their Insurance budget for the month, insurance-related advertisements may be displayed to the user 102. Further, the premium options may include Independent Contractor, and Small Business Editions. Examples of the financial services may include using an index stored in the database 212 of the finance management system to refer refinancing, loan, and mortgage services as well as tax refund.

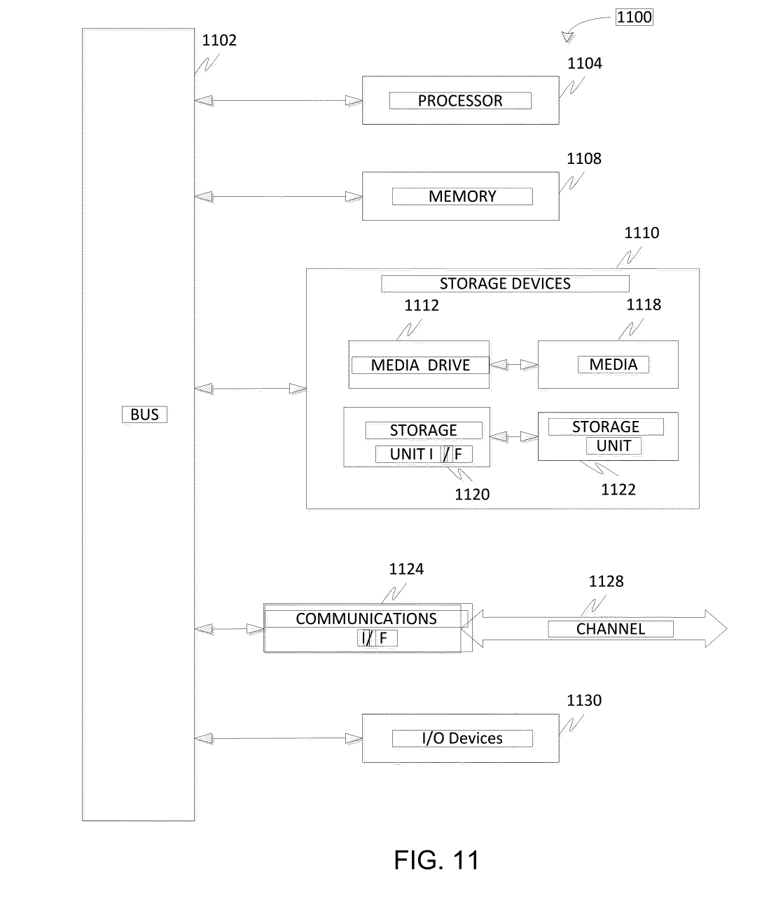

FIG. 11 is a schematic illustrating a functional block diagram of a computing device and system on a network in which the present disclosure can find application. FIG. 11 further illustrates an exemplary computing system or a networked computing device 1100 such as those described in FIGS. 1A-1E, and FIG. 2 that may be employed to implement processing functionality for various embodiments of the disclosed subject matter. For example, the computing system 1100 is configured to facilitate a user to manage his/her finances such as, budget, net worth, projects, and so forth. The computing system 1100 may represent, for example, a user device such as a computing device, a mobile phone, a laptop computer, a personal computer, a server, a scanner, shared memories, multi-function device, controllers for such devices or any other type of special or general purpose computing device as may be desirable or appropriate for a given application or environment. In some embodiments, the computing device 1100 includes a finance management system or a special finance management driver or application having its own set of finance management tools associated with a computer. The finance management driver or application will have a graphical user interface (GUI) associated with it. The GUI and techniques described above in FIGS. 3, 4, 5, 6, 7, 8A-8B, 9A, 9B, and 10 can be used with the computing device 1100 or with software associated with the finance management application or system, such as, for example, daily budget management software.

The computing system 1100 can include one or more processors, such as a processor 1104. The processor 1104 can be implemented using a general or special purpose processing engine such as, for example, a microprocessor, microcontroller or other control logic. In this example, the processor 1104 is connected to a data pathway (e.g., buses, Ethernet) 1102 or other communication medium. Although only one processor 1104 is shown, in certain embodiments, the computing system 1100 may include more processors in an expanded or distributed design.

The computing system 1100 can also include a main memory 1106, preferably random access memory (RAM) or other dynamic memory, for storing information and instructions to be executed by the processor 1104. The processor 1104 accepts instructions and data from the memory 1106 and performs various data processing functions of the system. These data processing functions may include, but are not limited to, providing graphical format objects via a graphical user interface, creating a graphical representation for a plurality of attributes, defining values of attributes based on selection of the graphical representation, executing operation on the computing system based on graphical representation and values of attributes, and so forth. The processor 1104 includes an arithmetic logic unit (ALU) that performs arithmetic and logical operations, and a control unit that extracts instructions from the memory 1106 and decodes and executes them, calling on the ALU when necessary. The main memory 1106 also may be used for storing temporary variables or other intermediate information during execution of instructions to be executed by the processor 1104. The memory 1106 stores a variety of data received by the computing device 1100 and computed by the various data processing functions of the system 1100. The data may include, for example, values of attributes, graphical format objects, graphical representations, and so forth.

The computing device/system 1100 may likewise include a read only memory (“ROM”) or other static storage device coupled to the data pathway 1102 for storing static information and instructions for the processor 1104. Also, the memory 1106 preferably contains an operating system, which executes on the processor 1104. The operating system performs basic tasks that include recognizing input, sending output to output devices, keeping track of files and directories and controlling various peripheral devices.

The computing system 1100 may also include information storage mechanism 1110, which may include, for example, a media drive 1112 and a removable storage interface 1120. The media drive 1112 may include a drive or other mechanism to support fixed or removable storage media, such as a hard disk drive, a floppy disk drive, a magnetic tape drive, an optical disk drive, a CD or DVD drive (R or RW), or other removable or fixed media drive. A storage media 1116 may include, for example, a hard disk, floppy disk, magnetic tape, optical disk, CD or DVD, or other fixed or removable medium that is read by and written to by media drive 1112. As these examples illustrate, storage media 616 may include a computer-readable storage medium having stored therein particular computer software or data.

In alternative embodiments, information storage mechanism 1110 may include other similar instrumentalities for allowing computer programs or other instructions or data to be loaded into the computing system 1100. Such instrumentalities may include, for example, a removable storage unit 1122 and an interface 1120, such as a program cartridge and cartridge interface, a removable memory (for example, a flash memory or other removable memory module) and memory slot, and other removable storage units 1122 and interfaces 1120 that allow software and data to be transferred from removable storage unit 1122 to the computing device/system 1100.

The computing device/system 1100 can also include a communications interface 1124 that enables the computing device/system 1100 to access other computers and resources on a communication network. The communications interface 1124 can be used to allow software and data to be transferred between computing device/system 1100 and external devices. Examples of communications interface 1124 can include a modem, a network interface (such as an Ethernet or other NIC card), a communications port (such as for example, a USB port), a PCMCIA slot and card, etc. Software and data transferred via communications interface 1124 are in the form of signals which can be electronic, electromagnetic, optical, or other signals capable of being received by the communications interface 1124. These signals are provided to the communications interface 1124 via a channel 1126. This channel 1126 may carry signals and may be implemented using a wireless medium, wire or cable, fiber optics, or other communications medium. Some examples of a channel include a phone line, a cellular phone link, an RF link, a network interface, a local or wide area network, and other communications channels. What is important is that the various computers and peripherals can interact to perform various finance management services.

The computing system 1100 further includes input/output devices 1130 such as a keyboard and a mouse that enables a user to enter data and instructions into the computing system 1100, a display device that enables the user to view the available information, and a printer that enables the user to print any data for his reference. Alternatively, the input/output devices 1130 may include a touch sensitive display that enables a user to enter data and instructions into the computing system 1100 as well as to view the available information

In this document, the terms “computer program product” and “computer-readable medium” may be used generally to refer to media such as, for example, memory 1106, storage device 1116, storage unit 1122, or signal(s) on channel 1126. These and other forms of computer-readable media may be involved in providing one or more sequences of one or more instructions to processor 1104 for execution. Such instructions, generally referred to as “computer program code” (which may be grouped in the form of computer programs or other groupings), when executed, enable the computing system 1100 to perform features or functions of embodiments of the disclosed subject matter.

In an embodiment where the elements are implemented using software, the software may be stored in a computer-readable medium and loaded into the computing system 1100 using, for example, the removable storage drive 1114, the drive 1112 or the communications interface 1124. The control logic (in this example, software instructions or computer program code), when executed by the processor 1104, causes the processor 1104 to perform the functions of the disclosed subject matter as described herein.

An aspect of the present disclosure allows the users to know their cash flow. In some embodiments, the finance management system allows the user to know their income after tax, and set their budget tracker, review uncategorized expenses, and so forth.

Another aspect of the present invention disclosure allows the users to know their net worth in terms of their assets and debts. In some embodiments, the finance management system allows the users to set their assets, set their debts, create their financial goals, and so forth.

A yet another aspect of the present invention disclosure allows the users to balance and keep a track of their money flow. In some embodiments, the finance management system allows the user to balance their budget, balance debt repayment schedule, balance goals advancement schedule, and so forth by selecting the “Reconcile” finance management option on the GUI.

In some embodiments, the finance management system also allows the user to review the money flow expenses in a particular time based on spending on the budget. The user can perform the money flow review from their smart phone, mobile phone, computer, laptop computer, tablet computer, and so forth. Further, the user can drag and drop or animate the movement of expenses into the appropriate budget tracker category (sub node) in the budget tracker. The user may see the change in their budget tracker and may gain a visceral understanding of the effect of spending on their budget.

In some embodiments, the finance management system allows the user to balance their money flow monthly. The financial management system and its various modules allows the users to set their monthly budget, reduce their debt by using Net Worth Interface, and may advance their financial goals.

An aspect of the present disclosure provides a basic, personal finance literacy which is powerful and simple for the users to understand.

Another aspect of the presently disclosed finance management system may provide a money flow credit index. The money flow credit index may be a score based on the user's participation within the finance management system providing an alternative credit score for the user. Upon approval of the user, the Index can be used with select partners of the finance management system to help the user refinance bad debt, and get better interest rates in things like car loans and mortgages.

In some embodiments, the financial management system may provide advice targeted to a group or community of users of the finance management system. The finance management system may provide support and accountability to help the users control their cash flow, build their net worth, overcome their financial challenges, and achieve financial goals. The user may engage in the community securely and anonymously based on their unique financial challenges and goals.

It will be understood that the managers and the databases referred to in the previous sections are not necessarily utilized together method or system of the embodiments. Rather, these managers are merely exemplary of the various managers that may be implemented within a device (imaging device or printing device), and can be implemented in exemplary another devices, and other devices as appropriate, that can communicate via a network to the exemplary imaging and printing devices.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed:

1. A method for managing finances of a user, comprising:
providing, by a display manager, a graphical user interface (GUI) including a plurality of finance management options to the user, wherein the GUI is displayed at a computing device of the user;
receiving, by an input/output (IO) module, a selection of at least one of the plurality of finance management options from the user;
requesting, by the IO module, one or more money flow inputs from the user based on the selection of the at least one of the plurality of finance management options;
generating, by a budget tracking module of a finance management system, a pictorial representation based on at least one of the selection of the at least one of the plurality of finance management options and received one or more money flow inputs, wherein the pictorial representation comprises at least one node and one or more sub nodes attached to the at least one node via one or more connectors;
displaying, by the display manager, the pictorial representation at the computing device using one or more colors and at least one financial indicator; and
allowing the user to manipulate the at least one of the node and the one or more sub nodes, wherein the user manipulates by selecting and dragging the at least one of the node and the one or more sub nodes.

2. The method of claim 1, wherein the node and the one or more sub nodes are represented using a plurality of colors depending on a predefined budget threshold value.

3. The method of claim 2, wherein each of the at least one node and the one or more sub nodes comprises a value.

4. The method of claim 3 further comprising receiving, by the IO module, information related to financial transactions of the user from a plurality of third party units.

5. The method of claim 4 further comprising:
comparing, by the budget tracking module, the value of each of the node or the sub nodes with the predefined budget threshold value; and
changing, by the budget tracking module, the color of the at least one of the node, the one or more sub nodes and at least one financial indicator of the at least one node and the one or more sub nodes based on the comparison.

6. The method of claim 5, wherein the at least one financial indicator indicates at least one of a statistical deviation from the predefined budget threshold value, a percentage of budged remaining based on the predefined budget threshold value, an amount remaining in a budget period, and number of days remaining in the budget period, further wherein the at least one financial indicators comprises colors that changes depending on the value associated with the at least one node and the one or more sub nodes.

7. The method of claim 6, wherein the at least one node is corresponding to a main subject matter, and the one or more sub nodes are corresponding to one or more categories associated with the at least one node.

8. The method of claim 7 further comprising categorizing, by a budget categorization module, a plurality of financial transactions into a plurality of categories depending on a type of the received information related to the financial transactions.

9. The method of claim 8 further comprising saving the one or more money flow inputs received from the user in a database.

10. The method of claim 9 further comprising:
receiving, by the JO module, a plurality of money flow inputs in real time from the plurality of third party units based on at least one financial transaction of the user;
updating, by the budget tracking module, the database based on the received plurality of money flow inputs;
updating, by the display manager, the pictorial representation based on the received plurality of money flow inputs in real time; and
displaying, by the display manager, the updated pictorial representation at the computing device of the user.

11. The method of claim 10, wherein the user is allowed to access the pictorial representation at a later time.

12. The method of claim 11, wherein the user is allowed to review the one or more of the at least one node and the sub nodes of the pictorial representation.

13. The method of claim 12, wherein the GUI comprises one or more project management options that the user uses to manage at least one project and associated tasks.

14. The method of claim 13 further comprising allowing, by a budget calendar module, the user to access a calendar comprising one or more financial events, wherein the user is allowed to set and check payments for the budget period.

15. The method of claim 14 further comprising tracking, by the budget-tracking module, the plurality of financial transactions of the user.

16. The method of claim 15 further comprising providing a net worth interface to the user for managing a plurality of assets and a plurality of debts of the user.

17. A system for managing finances of a user, comprising:
a graphical user interface (GUI) including a plurality of finance management options to the user, wherein the GUI is displayed at a computing device of the user;
an input/output (IO) interface configured to:
receive a selection of at least one of the plurality of finance management options from the user; and
receive one or more money flow inputs based on the selection of the at least one of the plurality of finance management options from the user;
a finance management system comprising:
a budget tracker configured to:
generate a pictorial representation based on at least one of the selection of the at least one of the plurality of finance management options and received one or more money flow inputs, wherein the pictorial representation comprises at least one node and one or more sub nodes attached to the at least one node via one or more connectors; and
allow the user to track the plurality of financial transactions associated with the user; and
a display manager configured to display the pictorial representation and the GUI at the computing device using one or more colors and at least one financial indicator; and
a database configured to store the one or more flow inputs and the pictorial representation;
wherein the user manipulates the at least one of the node and the one or more sub nodes by selecting and dragging the at least one of the node and the one or more sub nodes.

18. The system of claim 17, wherein the at least one node and the one or more sub nodes are represented using a plurality of colors depending on a predefined budget threshold value, further, wherein each of the at least one node and the one or more sub nodes includes at least one associated value.

19. The system of claim 18, wherein the one or more connectors include one or more colors, wherein the one or more colors of the one or more connectors varies depending on the predefined budget threshold value.

20. The system of claim 19, wherein each of the at least one node and the one or more sub nodes comprises at least one financial indicator, wherein the at least one financial indicator comprises the plurality of colors, further wherein the plurality of colors of the at least one financial indicator varies based on the predefined budget threshold value.

21. The system of claim 20, wherein the at least one financial indicator indicates at least one of a statistical deviation from the predefined budget threshold value, a percentage of budged remaining based on the predefined budget threshold value, an amount remaining in a budget period, and number of days remaining in the budget period.

22. The system of claim 21, wherein the budget tracking module is further configured to:
compare the value of at least one of the at least one node and the one or more sub nodes with the predefined budget threshold value; and
change the color of the at least one of the at least one node, the one or more sub nodes, and at least one financial indicator of the at least one node and the one or more sub nodes based on the comparison.

23. The system of claim 22, wherein the at least one node is corresponding to a main subject matter, and the one or more sub nodes are corresponding to one or more categories associated with the at least one node.

24. The system of claim 23, wherein the finance management system further comprising a budget categorization module configured to categorize a plurality of financial transactions into a plurality of categories.

25. The system of claim 24, wherein the IO module is configured to receive a plurality of money flow inputs in real time from at least one third party unit based on at least one financial transaction of the user.

26. The system of claim 25, wherein the budget tracking module is configured to update the pictorial representation based on the received money flow inputs in real time, wherein the updated pictorial representation is displayed at the computing device of the user by the display manager.

27. The system of claim 26, wherein the budget tracking module is further configured to allow the user to review the pictorial representation.

28. The system of claim 27, wherein the GUI comprises one or more project management options.

29. The system of claim 28, wherein the finance management system further comprises a budget calendar module configured to allow the user to access a calendar comprising one or more financial events, wherein the user is allowed to set and check payments for the budget period.

30. The system of claim 29 further comprising a net worth interface to the user for managing a plurality of assets and a plurality of debts of the user.
